(19) United States
(12) Patent Application Publication
(10) Pub. No.: US 2011/0165511 A1
(43) Pub. Date: Jul. 7, 2011

(54) METHOD FOR PRODUCING TONER

(76) Inventors: Shunquan ZHU, Wuhan (CN); Yunfeng LI, Wuhan (CN)

(21) Appl. No.: 12/832,090

(22) Filed: Jul. 8, 2010

Related U.S. Application Data
(63) Continuation of application No. PCT/CN2010/070524, filed on Feb. 5, 2010.

(30) Foreign Application Priority Data
Jan. 6, 2010 (CN) 201010028920.6

(51) Int. Cl. G03G 9/08

(52) U.S. Cl. 430/137.15

(57) ABSTRACT

A method for producing an electrostatic image developing toner by: a) adding a free radical polymerizable monomer to an aqueous medium comprising dispersed wax particles containing a colorant, b) polymerizing the free radical polymerizable monomer to yield a resin particle comprising the wax and colorant, and c) agglutinating and fusing the resin particle in the aqueous medium to yield a toner. The resultant toner exhibits uniform particle size, high roll viscosity resistance, and high durability.

### CROSS-REFERENCE TO RELATED APPLICATIONS

This application is a continuation of International Patent Application No. PCT/CN2010/070524 with an international filing date of Feb. 5, 2010, designating the United States, now pending, and further claims priority benefits to Chinese Patent Application No. 201010028920.6 filed Jan. 6, 2010. The contents of all of the aforementioned applications, including any intervening amendments thereto, are incorporated herein by reference.

### BACKGROUND OF THE INVENTION

1. Field of the Invention

The invention relates to a method for producing an electrostatic image developing toner.

2. Description of the Related Art

The most widely used method for producing an electrostatic image developing toner involves melt-blending a colorant composed of a dye and carbon black, a release agent composed of wax, and a styrene acrylic resin or polyester resin to form a uniform dispersion. The blended matter is then pulverized and classified to separate out toner particles of the desired particle size. However, the particle size distribution of the toner obtained by the above method is limited. To obtain high yield of particles with diameter less than 10 μm, particularly less than 8 μm, is a very difficult problem. Conventional methods can-not meet the particle size requirement for achieving high resolution electrophotography.

The procedure of melt-blending is a general oil-free fixation method that disperses a wax with low softening point in a toner. In conventional melt-blending/pulverizing methods, if too much wax is added, wax detachment or surplus may occur, which contaminates a carrier or an imaging sleeve and reduces the durability. Moreover, formation of a wax film on a photoreceptor leads to image defects. The detachment of wax prevents complete fixation at low temperature.

To overcome the problems of particle size control and to achieve toners suitable for high resolution printing, Japan Patent Publication No. 63-186253 discloses a method for producing a toner by emulsion polymerization/agglutination. The method involves agglutinating resin particles, wax particles, and colorants, and as mentioned above, if an excess of wax is added, wax detachment may occur, which contaminates a carrier or an imaging sleeve. Furthermore, a wax film may form on the photoreceptor. These properties will reduce the durability of the toner.

Japan Patent Publication No. 2001-27821 discloses a method for producing a toner by agglutinating colorants and polymer particles. The method uses wax particles as a seed. According to the method, the toner includes a high wax content, which improves the fixation characteristics. However, the colorants have a low dispersion rate, do not improve the image density, and detach easily, resulting in the contamination of carriers or imaging sleeves and low toner durability.

### SUMMARY OF THE INVENTION

In view of the above-described problems, it is an objective of the invention to provide a method for producing an electrostatic image developing toner featuring high roll viscosity resistance and high durability.

Studies have shown that the following method can achieve the objectives. To an aqueous medium comprising dispersed wax particles containing a colorant, a free radical polymerizable monomer is added. The free radical polymerizable monomer is polymerized into a resin particle that is further agglutinated and fused in the medium to yield a toner.

Specifically, by the method, wax and colorants are included inside the polymer particles. To wax particles containing colorants, the free radical polymerizable monomer is added, polymerized, agglutinated, and fused to form toner particles. Thus, the colorants and wax are dispersed in the toner in a particle size which is much smaller than the size of the polymer particles. Because wax has already been included inside the polymer particle, agglutination and fusion do not result in detachment of the wax from the toner.

Optionally, a resin particle containing colorants or a resin particle containing wax can be prepared first and then agglutinated. However, the method involves different processes with low yields. Upon polymerization, problems such as the adjustment of the molecular weight and the dispersion of colorants or wax will occur, and after a long operation period, the roll viscosity will increase.

In the invention, a free radical polymerizable monomer is added to an aqueous dispersion comprising wax particles containing a colorant. The monomer is polymerized using the wax as a seed, and thereby a resin particle containing colorants and a resin particle containing wax are formed under the same conditions, the resin characteristics have no difference. Furthermore, the heat characteristics of agglutination and fusion are identical, so the wax and colorants will not mutually separate.

In accordance with one embodiment of the invention, there is provided a method for producing an electrostatic image developing toner featuring a high roll viscosity resistance and a high durability, the method comprising the steps of: a) adding a free radical polymerizable monomer to an aqueous medium comprising dispersed wax particle(s) containing a colorant; b) polymerizing the free radical polymerizable monomer to yield a resin particle(s) comprising the wax and the colorant; and c) agglutinating and fusing the resin particle(s) in the aqueous medium to yield a toner.

In a class of this embodiment, the wax is an olefin wax (such as a low molecular weight polyethylene, low molecular weight polypropylene, or copolymerized polyethylene); a hydrocarbon wax (such as paraffin or microcrystalline wax); a long-chain aliphatic-based ester wax (such as docosanoic acid docosyl ester, lignite acid docosyl ester, stearic acid stearyl, or pentaerythritol tetrabehenate); a natural wax (such as carnauba wax or beeswax); or a higher fatty acid amide (such as oleic acid amide and stearic amide). To improve the fixation performance at low temperatures, the melting point of the wax should be less than 100° C., preferably 40-90° C., and more preferably 60-85° C. If the melting point exceeds 100° C., the fixation performance at low temperatures will decrease.

In a class of this embodiment, the colorant is an inorganic pigment, an organic pigment, an organic dye, or a mixture thereof. For example, black colorants: carbon black, magnetite, titanium black, aniline black, or aniline black dyestuffs; cyan colorants: pigment blue 15:3, pigment blue 15:4, etc.; yellow colorants: pigment yellow 14, pigment yellow 17, pigment yellow 93, pigment yellow 94, pigment yellow 138, pigment yellow 150, pigment yellow 155, pigment yellow 180, pigment yellow 185, solvent yellow 19, solvent yellow 44, solvent yellow 77, solvent yellow 162, etc.; magenta colorants: pigment red 5, pigment red 48:1, pigment red 48:2, pigment red 48:3, pigment red 53:1, pigment red 57:1, pigment red 122, etc.

Because colorants have a high polarity, to disperse colorants in wax, a polar wax is preferable. Therefore, ester wax is a good choice. If a non-polar carbohydrate wax, such as paraffin, is used, the low polarity results in a low affinity between the wax and the colorants. Mixing with an ester wax is a good method for increasing the polarity of the wax.

For a preparation that includes 100 parts by weight of an adhesive resin, the added colorant is 1-40 parts by weight, and more preferably 2-30 parts by weight, and the added wax is 3-20 parts by weight.

To disperse the colorants in the wax, the following steps are used. A mixture of wax and colorants is melt-blended using dry melt-blending equipment, such as a biaxial extruder, a two-roll mill, or a three-roll mill, to yield wax particles with dispersed colorants. The suspension is subsequently dispersed in an aqueous medium to yield wax particles containing colorants. Another method may be optionally employed. That is, wax is melted into a liquid and the colorants added. The mixture is then dispersed by a sand mill or an SC mill, and then further dispersed in an aqueous medium to yield wax particles containing colorants.

To stably disperse the wax particle containing colorants in the aqueous medium, a surfactant, such as a cationic surfactant, an anionic surfactant, a non-ionic surfactant, or a mixture thereof, is added. The cationic surfactant may be dodecyl ammonium chloride, dodecyl ammonium bromide, dodecyltrimethyl ammonium bromide, dodecyl pyridyl chloride, dodecyl pyridyl bromide, cetyltrimethyl ammonium bromide, etc. The anionic surfactant may be sodium stearate, sodium laurate, sodium dodecyl sulfate, sodium dodecyl benzene sulfonate, sodium dodecyl sulfate, etc. The non-ionic surfactant may be poly(oxyethylene)dodecy ether, poly(oxyethylene)hexadecyl ether, poly(oxyethylene)nonyl-phenyl ether, poly(oxyethylene)lauryl ether, sorbitan mono-oleate poly(oxyethylene)ether, monodecanoate sucrose, etc.

In the presence of surfactant, wax containing colorants are dispersed to form particles. The average diameter of the wax particles is between 10 and1000 nm, preferably between 30 and 500 nm. The average diameter is determined using LS230 instrument (manufactured by Beckman Coulter Inc.).

If the average particle diameter of the wax particle exceeds 1000 nm, the agglutination of wax particles and resin particles will be inhomogenous, which severely encumbers the process of narrowing the particle diameter distribution to obtain small particles of toner. In contrast, if the average diameter of the wax particle is less than 10 nm, the amount of wax in the toner is low, which may produce a low roll viscosity resistance during fixation at low temperatures.

There are many methods for dispersing wax particles containing colorants in the aqueous medium. For example, a high-speed rotating device may be used, for example, a CLEARMIX (manufactured by M technique Co.), a TK homogenizer (manufactured by PRIMIX Co.), an SC mill (manufactured by Mitsui Mining Co., Ltd.), or a sand mill.

To disperse the wax particles containing colorants, the wax is heated to above the melting point and then is dispersed in the aqueous medium.

In the invention, the toner is prepared by preparing a dispersion of wax particles containing colorants, to which the free radical polymerizable monomer and a polymerizable initiator added are added, as needed. The free radical polymerizable monomer is polymerized and a resin particle containing the colorant and wax is obtained. The resin particle is agglutinated and fused to yield the toner.

In a class of this embodiment, the free radical polymerizable monomers is styrene, α-methyl styrene, chlorine styrene, dichlorostyrene, p-tert-butyl styrene, p-n-butyl styrene, p-n-nonyl styrene, or acrylate ester, such as methyl acrylate, ethyl acrylate, propyl acrylate, butyl acrylate, iso-butyl acrylate, 2-hydroxyethyl acrylate, ethylhexyl acrylate, methyl methacrylate, ethyl methacrylate, propyl methacrylate, butyl methacrylate, iso-butyl methacrylate, hydroxyethyl methacrylate, ethylhexyl methacrylate, etc. The preferable monomer is styrene and butyl acrylate.

A polar free radical polymerizable monomer can be used. Acid-polarity based monomer can be carboxylic acid-based radical polymerizable monomer, such as acrylic acid, methacrylate, maleic acid, fumaric acid, and cinnamic acid, and sulfonic-based free radical polymerizable monomer, such as sulfonated styrene. The preferable monomer is acrylic acid or methacrylic acid.

An alkaline-polar free radical polymerizable monomer comprises nitrogen heterocyclic rings, such as amino styrene or a quaternary salt thereof, vinyl pyridine, vinylpyrrolidone, amino-based acrylic ester such as dimethylamino ethyl acrylate, diethylamino ethyl methacrylate, and acrylate esters with quaternary amino, acrylamide, N-propyl acrylamide, N,N-dimethyl acrylamide, N,N-dipropyl acrylamide, N,N-dibutyl acrylamide, ammonium acrylate, etc.

These free radical polymerizable monomers can be used alone or in combination with others, and the glass transition temperature of the polymer is preferably between 40 and 70° C. If the glass transition temperature exceeds 70° C., the fixing temperature is too high, and the fixation properties will decrease; on the other hand, if the glass transition temperature is less than 40° C., the preservation stability of the toner decreases, and aggregation may occur.

In a class of this embodiment, the polymerizable initiator is a water soluble persulfate, such as potassium persulfate, sodium persulfate, or ammonium persulfate, and a redox polymerization initiator composed of above-mentioned persulfates and a reducing agent, such as acid sodium sulfite or ascorbic acid. Moreover, the polymerizable initiator can also be a water soluble initiator, such as hydrogen peroxide, 4,4′-azobis(4-cyanovaleric acid), tert-butyl hydroperoxide, cumene hydroperoxide, and a redox polymerization initiator composed of above-mentioned water-soluble polymerization initiators and a reducing agent such as ferrous salt or ascorbic acid. These polymerizable initiators can be added to polymerization systems before, during, or any time after the radical polymerizable monomer is added. These addition methods may be used in combination, as needed.

To adjust the molecular weight of the polymer of the invention, a chain transition agent can be used, as necessary. The chain transition agent is t-dodecyl mercaptan, n-dodecyl mercaptan, 2-mercapto ethanol, diisopropyl xanthogen, carbon tetrachloride, trichloromethyl bromide, or a mixture thereof. Based on the total amount of the free radical polymerizable monomer, the largest quantity of the chain transition agent preferably does not exceed 5% by weight. When the chain transition agent is present in excess, with decrease of the molecular weight, the residue of the free radical polymerizable monomer will increase, which may result in a sharp smell.

The average particle diameter of the resin particles is preferably between 50-1500 nm, more preferably 70-700 nm. The average particle diameter can be determined using LS230 instrument (manufactured by Beckman Coulter Inc.). When the average particle diameter is less than 50 nm, the low wax content produces a bad release effect. When the diameter exceeds 1500 nm, control over the toner particle diameter is difficult, and the particle size distribution will be wide.

In the invention, a charge control agent can be added to the toner. The charge control agent can be any common compound in the art and can be used alone or in combination with other compound. Preferably, a positive charge control agent is a quaternary amine salt, and a negative charge control agent is a metal salt or a metal complex of salicylic acid, alkyl salicylic acid, or benzoic acid wherein the metal is chromium, zinc, or aluminum, an amino compound, a phenol compound, a naphthol compound, an aminophenol compound, etc. The usage amount of the charge control agent is determined by the expected electric charge of the toner. If the binding resin is 100 parts by weight, the charge control agent is preferably between 0.01 and 10 parts by weight, more preferably between 0.1 and 10 parts by weight.

The charge control agent can be used in the presence of the colorants and the wax particles, or be separately dispersed in the aqueous medium and agglutinated with the above-mentioned resin particle.

A method of agglutinating the resin particle is described below. The resin particle dispersion solution is dispersed and agglutinated by heating or modifying the pH value, then is fused by heating. Optionally, an agglutinating salt is added for agglutination and then the mixture is fused by heating. The latter method is preferable because a stable agglutinating state can be formed.

The agglutinating salt is a univalent or multivalent metal salt. Specifically, the univalent metal salt is a sodium salt or a potassium salt, for example, sodium chloride, potassium chloride, etc. A bivalent metal salt is magnesium chloride, magnesium sulfate, calcium chloride, calcium sulfate, etc. A trivalent metal salt is aluminum hydroxide, aluminum chloride, etc.

Upon agglutinating and fusing resin particles by heating, the agglutinating salt is added at a temperature below the glass transition temperature of the polymer particle, and the temperature is subsequently increased as quickly as possible to above the glass transition temperature of the polymer particle. Preferably, the time for increasing the temperature does not exceed one hour. Moreover, the temperature increase must be rapid, and the heating rate is preferably more than 0.25° C./min. The upper limit is not definite, but if the temperature rises instantaneously, the dramatic salting out will occur, and it will be very difficult to control the particle size. Thus, the preferable heating rate does not exceed 5° C./min. Via fusion, the dispersion solution of the polymer particle and the colorant is obtained.

Subsequently, by filtering and rinsing, colorant particles are separated from the aqueous medium. The method used for filtering and rinsing is centrifugal separation, vacuum filtration by a suction filter, or filtering by a filter press.

The rinsed filter cake containing colorant particle is dried using a dryer. The dryer can be a spray dryer, a vacuum freeze dryer, a vacuum dryer, a static shed dryer, a mobile shed dryer, a fluid layer dryer, a rotary dryer, or a stirring dryer. The water content of the dried colorant particle preferably does not exceed 5% by weight, more preferably less than 2% by weight. After the dried colorant particles are agglutinated by relatively weak attractive force between particles, the agglutination group can be pulverized. The pulverizing device can be a jet mill, a Henshel mixer, a coffee mill, a food processing machine, etc.

During preparing the toner of the invention, as the particle diameter of the agglutinating particle achieves the expected particle size, adhesive resin emulsion, either identical or different from that used above, can be added to adhere to the particle surface, thereby modifying the toner properties around the surface.

In the invention, an additive, such as a flowable agent can be added to the toner, as needed. The flowable agent is hydrophobic silicon dioxide, titanium dioxide, alumina, etc. The usage amount of the flowable agent is usually 0.01-5 parts by weight based on 100 parts of adhesive resins by weight, preferably 0.1-3 parts. The average particle diameter of these flowable agents is preferably between 5 and 80 nm.

Upon preparing the toner, inorganic micro powder such as magnetite, ferrite, cerium oxide, strontium titanate, conductive titanium dioxide, or a resistance regulator such as styrene resin, acrylic resin, etc. and a slip agent can be added as an internal additive or an external additive. The usage amount of these additives is determined as needed, preferably 0.05-10 parts by weight based on 100 parts of adhesive resins by weight. A relatively large particle size of additives is preferable, with the average particle diameter of between 100 and 1000 nm.

The toner of the invention for developing electrostatic image can be used in a two-component developer or a non-magnetic one-component developer. When the toner is used as a two-component developer, the carrier can be a magnetic material, such as iron powders, magnetite powders, ferrite powders etc., or the magnetic material having coated resin on the surface, or a magnetic carrier. The coated resin is styrene resin, acrylic resin, styrene-acrylic acid copolymer resin, silicone resin, modified silicone resin, fluorine resin, or a mixture thereof.

### DETAILED DESCRIPTION OF THE INVENTION

For further illustrating the invention, experiments detailing a method for producing an electrostatic image developing toner featuring a high roll viscosity resistance and a high durability are described below. It should be noted that the following examples are intended to describe and not to limit the invention.

### EXAMPLE 1

Preparing Wax Particle Containing Colorant 1

100 g of docosanoic acid docosyl ester and 10 g of carbon black were dry mixed using a Henshel mixer and melt-blended by a two-mill roller. The mixture was cooled to yield a product of docosanoic acid docosyl ester containing carbon black. 30 g of the product were collected, heated to 85° C. to melt the docosanoic acid docosyl ester, and added to 200 g of a 5 wt. % sodium dodecyl benzene sulfonate solution that had been heated to 85° C. The solution was dispersed using a CLEAMIX instrument to yield a number average primary particle size of 120 nm and then cooled to 30° C. to yield a dispersion solution of docosanoic acid docosyl ester containing carbon black. The particle size was determined by LS230 (manufactured by Beckman Coulter Inc.). The dispersion solution is referred to as a dispersion solution of wax particle containing colorant (1).

### EXAMPLE 2

Preparing Wax Particle Containing Colorant 2

The preparation process was the same as that in Example 1 except that docosanoic acid docosyl ester was substituted with No. 1 carnauba wax. Obtained is a dispersion solution of No. 1 carnauba wax containing carbon black with a number average primary particle size of 105 nm. The dispersion solution is referred to as a dispersion solution of wax particle containing colorant (2).

### EXAMPLE 3

Preparing Wax Particle Containing Colorant 3

The preparation process was the same as that in Example 1 except that docosanoic acid docosyl ester was substituted with pentaerythritol tetrabehenate. Obtained is a dispersion solution of pentaerythritol tetrabehenate containing carbon black with a number average primary particle size of 145 nm. The dispersion solution is referred to as a dispersion solution of wax particle containing colorant (3).

### EXAMPLE 4

Preparing Wax Particle Containing Colorant 4

The preparation process was the same as that in Example 1 except that carbon black was substituted with pigment red 122. Obtained is a dispersion solution of docosanoic acid docosyl ester containing pigment red 122 with a number average primary particle size of 145 nm. The dispersion solution is referred to as a dispersion solution of wax particle containing colorant (4).

### EXAMPLE 5

Preparing Wax Particle Containing Colorant 5

The preparation process was the same as that in Example 2 except that carbon black was substituted with pigment red 122. Obtained is a dispersion solution of No. 1 carnauba wax containing pigment red 122 with a number average primary particle size of 135 nm. The dispersion solution is referred to as a dispersion solution of wax particle containing colorant (5).

### EXAMPLE 6

Preparing Wax Particle Containing Colorant 6

The preparation process was the same as that in Example 3 except that carbon black was substituted with pigment red 122. Obtained is a dispersion solution of pentaerythritol tetrabehenate containing pigment red 122 with a number average primary particle size of 155 nm. The dispersion solution is referred to as a dispersion solution of wax particle containing colorant (6).

### EXAMPLE 7

Preparing Wax Particle Containing Colorant 7

The preparation process was the same as that in Example 1 except that carbon black was substituted with pigment yellow 74. Obtained is a dispersion solution of docosanoic acid docosyl ester containing pigment yellow 74 with a number average primary particle size of 135 nm. The dispersion solution is referred to as a dispersion solution of wax particle containing colorant (7).

### EXAMPLE 8

Preparing Wax Particle Containing Colorant 8

The preparation process was the same as that in Example 2 except that carbon black was substituted with pigment yellow 74. Obtained is a dispersion solution of No. 1 carnauba wax containing pigment yellow 74 with a number average primary particle size of 115 nm. The dispersion solution is referred to as a dispersion solution of wax particle containing colorant (8).

### EXAMPLE 9

Preparing Wax Particle Containing Colorant 9

The preparation process was the same as that in Example 3 except that carbon black was substituted with pigment yellow 74. Obtained is a dispersion solution of pentaerythritol tetrabehenate containing pigment yellow 74 with a number average primary particle size of 145 nm. The dispersion solution is referred to as a dispersion solution of wax particle containing colorant (9).

### EXAMPLE 10

Preparing Wax Particle Containing Colorant 10

The preparation process was the same as that in Example 1 except that carbon black was substituted with pigment blue 15:3. Obtained was a dispersion solution of docosanoic acid docosyl ester containing pigment blue 15:3 with a number average primary particle size of 125 nm. The dispersion solution is referred to as a dispersion solution of wax particle containing colorant (10).

### EXAMPLE 11

Preparing Wax Particle Containing Colorant 11

The preparation process was the same as that in Example 2 except that carbon black was substituted with pigment blue 15:3. Obtained is a dispersion solution of No. 1 carnauba wax containing pigment blue 15:3 with a number average primary particle size of 105 nm. The dispersion solution is referred to as a dispersion solution of wax particle containing colorant (11).

### EXAMPLE 12

Preparing Wax Particle Containing Colorant 12

The preparation process was the same as that in Example 3 except that carbon black was substituted with pigment blue 15:3. Obtained is a dispersion solution of pentaerythritol tetrabehenate containing pigment blue 15:3 with a number average primary particle size of 135 nm. The dispersion solution is referred to as a dispersion solution of wax particle containing colorant (12).

### EXAMPLE 13

Preparing Wax Particle Containing Colorant 13

To 100 g of docosanoic acid docosyl ester which was heated to 90° C. for melting, as a dispersion additive 0.05 g of lecithin was added. The mixture was dispersed at a high speed by a sand mill and meanwhile 50 g of carbon black was gradually added. The mixture was further dispersed until the number average primary particle size of the carbon black was less than 80 nm. The mixture was separated and cooled to yield a product of docosanoic acid docosyl ester containing carbon black. 30 g of the product were collected, heated to 85° C. to melt the docosanoic acid docosyl ester, and added to 200 g of a 5 wt. % sodium dodecyl benzene sulfonate solution which had been heated to 85° C. The solution was dispersed using a CLEAMIX instrument to yield a number average primary particle size of 120 nm and then cooled to 30° C. to yield a dispersion solution of docosanoic acid docosyl ester containing carbon black. The particle size was determined by LS230 (manufactured by Beckman Coulter Inc.). The dispersion solution is referred to as a dispersion solution of wax particle containing colorant (13).

### EXAMPLE 14

Preparing Wax Particle Containing Colorant 14

The preparation process was the same as that in Example 13 except that carbon black was substituted with pigment red 122. Obtained is a dispersion solution of docosanoic acid docosyl ester containing pigment red 122 with a number average primary particle size of 155 nm. The dispersion solution is referred to as a dispersion solution of wax particle containing colorant (14).

### EXAMPLE 15

Preparing Wax Particle Containing Colorant 15

The preparation process was the same as that in Example 13 except that carbon black was substituted with pigment yellow 74. Obtained is a dispersion solution of docosanoic acid docosyl ester containing pigment yellow 74 with a number average primary particle size of 145 nm. The dispersion solution is referred to as a dispersion solution of wax particle containing colorant (15).

### EXAMPLE 16

Preparing Wax Particle Containing Colorant 16

The preparation process was the same as that in Example 13 except that carbon black was substituted with pigment blue 15:3. Obtained is a dispersion solution of docosanoic acid docosyl ester containing pigment blue 15:3 with a number average primary particle size of 135 nm. The dispersion solution is referred to as a dispersion solution of wax particle containing colorant (16).

### EXAMPLE 17

Preparing Resin Particle 1

To a glass reaction vessel equipped with a stirring device, a heating-cooling device, a concentration device, and an inlet for materials, the wax particle containing colorant (1) was added and heated to 40° C. Subsequently, 800 g of an aqueous solution comprising a 5 wt. % sodium dodecyl benzene sulfonate and as a polymerization initiator 1.2 g of potassium persulfate were added. The resultant mixture was heated to 85° C., and a monomer solution comprising 70 g of styrene, 20 g of butyl acrylate, and 10 g of methacrylic acid was dripped within an hour for polymerization with the wax particle containing colorant (1) as a seed. 7 hours later, the reaction was terminated and the polymer (resin particle containing wax and colorants) was cooled to 20° C. The resin particle containing wax and colorants had a particle size of 220 nm and is referred to as resin particle (1).

### EXAMPLE 18

Preparing Resin Particle 2

The preparation process was the same as that for preparing resin particle 1 except that the wax particle containing colorant (1) was substituted with the wax particle containing colorant (2). Obtained is a resin particle containing wax and colorants and with a particle size of 230 nm. The resin particle containing wax and colorants is referred to as resin particle (2).

### EXAMPLE 19

Preparing Resin Particle 3

The preparation process was the same as that for preparing resin particle 1 except that the wax particle containing colorant (1) was substituted with the wax particle containing colorant (3). Obtained is a resin particle containing wax and colorants and with a particle size of 250 nm. The resin particle containing wax and colorants is referred to as resin particle (3).

### EXAMPLE 20

Preparing Resin Particle 4

The preparation process was the same as that for preparing resin particle 1 except that the wax particle containing colorant (1) was substituted with the wax particle containing colorant (4). Obtained is a resin particle containing wax and colorants and with a particle size of 240 nm. The resin particle containing wax and colorants is referred to as resin particle (4).

### EXAMPLE 21

Preparing Resin Particle 5

The preparation process was the same as that for preparing resin particle 1 except that the wax particle containing colorant (1) was substituted with the wax particle containing colorant (5). Obtained is a resin particle containing wax and colorants and with a particle size of 220 nm. The resin particle containing wax and colorants is referred to as resin particle (5).

### EXAMPLE 22

Preparing Resin Particle 6

The preparation process was the same as that for preparing resin particle 1 except that the wax particle containing colorant (1) was substituted with the wax particle containing colorant (6). Obtained is a resin particle containing wax and colorants and with a particle size of 240 nm. The resin particle containing wax and colorants is referred to as resin particle (6).

### EXAMPLE 23

Preparing Resin Particle 7

The preparation process was the same as that for preparing resin particle 1 except that the wax particle containing colorant (1) was substituted with the wax particle containing colorant (7). Obtained is a resin particle containing wax and colorants and with a particle size of 250 nm. The resin particle containing wax and colorants is referred to as resin particle (7).

### EXAMPLE 24

Preparing Resin Particle 8

The preparation process was the same as that for preparing resin particle 1 except that the wax particle containing colorant (1) was substituted with the wax particle containing colorant (8). Obtained is a resin particle containing wax and colorants and with a particle size of 240 nm. The resin particle containing wax and colorants is referred to as resin particle (8).

### EXAMPLE 25

Preparing Resin Particle 9

The preparation process was the same as that for preparing resin particle 1 except that the wax particle containing colorant (1) was substituted with the wax particle containing colorant (9). Obtained is a resin particle containing wax and colorants and with a particle size of 230 nm. The resin particle containing wax and colorants is referred to as resin particle (9).

### EXAMPLE 26

Preparing Resin Particle 10

The preparation process was the same as that for preparing resin particle 1 except that the wax particle containing colorant (1) was substituted with the wax particle containing colorant (10). Obtained is a resin particle containing wax and colorants and with a particle size of 245 nm. The resin particle containing wax and colorants is referred to as resin particle (10).

### EXAMPLE 27

Preparing Resin Particle 11

The preparation process was the same as that for preparing resin particle 1 except that the wax particle containing colorant (1) was substituted with the wax particle containing colorant (11). Obtained is a resin particle containing wax and colorants and with a particle size of 230 nm. The resin particle containing wax and colorants is referred to as resin particle (11).

### EXAMPLE 28

Preparing Resin Particle 12

The preparation process was the same as that for preparing resin particle 1 except that the wax particle containing colorant (1) was substituted with the wax particle containing colorant (12). Obtained is a resin particle containing wax and colorants and with a particle size of 250 nm. The resin particle containing wax and colorants is referred to as resin particle (12).

### EXAMPLE 29

Preparing Resin Particle 13

The preparation process was the same as that for preparing resin particle 1 except that the wax particle containing colorant (1) was substituted with the wax particle containing colorant (13). Obtained is a resin particle containing wax and colorants and with a particle size of 260 nm. The resin particle containing wax and colorants is referred to as resin particle (13).

### EXAMPLE 30

Preparing Resin Particle 14

The preparation process was the same as that for preparing resin particle 1 except that the wax particle containing colorant (1) was substituted with the wax particle containing colorant (14). Obtained is a resin particle containing wax and colorants and with a particle size of 230 nm. The resin particle containing wax and colorants is referred to as resin particle (14).

### EXAMPLE 31

Preparing Resin Particle 15

The preparation process was the same as that for preparing resin particle 1 except that the wax particle containing colorant (1) was substituted with the wax particle containing colorant (15). Obtained is a resin particle containing wax and colorants and with a particle size of 240 nm. The resin particle containing wax and colorants is referred to as resin particle (15).

### EXAMPLE 32

Preparing Resin Particle 16

The preparation process was the same as that for preparing resin particle 1 except that the wax particle containing colorant (1) was substituted with the wax particle containing colorant (16). Obtained is a resin particle containing wax and colorants and having a particle size of 250 nm. The resin particle containing wax and colorants is referred to as resin particle (16).

### EXAMPLE 33

Preparing Toner 1

A dispersion solution of the resin particle (1) was stirred at 30° C. and 300 g of 20% magnesium chloride solution was dripped within 30 min. Subsequently, the temperature was raised to 80° C. and the growth of the particle size was monitored. When the particle size (median size of volume basis: determined by Kurt Multi sizer II manufactured by Beckman Coulter Inc.) reached 6.5 μm, 300 g of water were added to stop the growth of the particle size. The temperature was further raised to 95° C., and spherical shape particles form gradually within 5 hours. After the shape coefficient reaches 0.965 (determined by FPIA-3000), the solution was cooled to 20° C., filtered by a centrifugal separator, rinsed by water, and dried by a vacuum dryer. 100 g of the dried particle were collected, and 1 g of hydrophobic silicon dioxide (treated with Hexamethyldisilazane, the number average primary particle size is 12 nm) and 0.5 g of hydrophobic titanium dioxide (treated with Octyltrimethyl silane, the number average primary particle size is 25 nm) were added. The resultant mixture was blended by a Henshel mixer to yield toner 1.

### EXAMPLE 34

Preparing Toner 2

The preparation process was the same as that for preparing toner 1 except that the resin particle (1) was substituted with the resin particle (2). The resultant toner is referred to as toner 2.

### EXAMPLE 35

Preparing Toner 3

The preparation process was the same as that for preparing toner 1 except that the resin particle (1) was substituted with the resin particle (3). The resultant toner is referred to as toner 3.

### EXAMPLE 36

Preparing Toner 4

The preparation process was the same as that for preparing toner 1 except that the resin particle (1) was substituted with the resin particle (4). The resultant toner is referred to as toner 4.

### EXAMPLE 37

Preparing Toner 5

The preparation process was the same as that for preparing toner 1 except that the resin particle (1) was substituted with the resin particle (5). The resultant toner is referred to as toner 5.

### EXAMPLE 38

Preparing Toner 6

The preparation process was the same as that for preparing toner 1 except that the resin particle (1) was substituted with the resin particle (6). The resultant toner is referred to as toner 6.

### EXAMPLE 39

Preparing Toner 7

The preparation process was the same as that for preparing toner 1 except that the resin particle (1) was substituted with the resin particle (7). The resultant toner is referred to as toner 7.

### EXAMPLE 40

Preparing Toner 8

The preparation process was the same as that for preparing toner 1 except that the resin particle (1) was substituted with the resin particle (8). The resultant toner is referred to as toner 8.

### EXAMPLE 41

Preparing Toner 9

The preparation process was the same as that for preparing toner 1 except that the resin particle (1) was substituted with the resin particle (9). The resultant toner is referred to as toner 9.

### EXAMPLE 42

Preparing Toner 10

The preparation process was the same as that for preparing toner 1 except that the resin particle (1) was substituted with the resin particle (10). The resultant toner is referred to as toner 10.

### EXAMPLE 43

Preparing Toner 11

The preparation process was the same as that for preparing toner 1 except that the resin particle (1) was substituted with the resin particle (11). The resultant toner is referred to as toner 11.

### EXAMPLE 44

Preparing Toner 12

The preparation process was the same as that for preparing toner 1 except that the resin particle (1) was substituted with the resin particle (12). The resultant toner is referred to as toner 12.

### EXAMPLE 45

Preparing Toner 13

The preparation process was the same as that for preparing toner 1 except that the resin particle (1) was substituted with the resin particle (13). The resultant toner is referred to as toner 13.

### EXAMPLE 46

Preparing Toner 14

The preparation process was the same as that for preparing toner 1 except that the resin particle (1) was substituted with the resin particle (14). The resultant toner is referred to as toner 14.

### EXAMPLE 47

Preparing Toner 15

The preparation process was the same as that for preparing toner 1 except that the resin particle (1) was substituted with the resin particle (15). The resultant toner is referred to as toner 15.

### EXAMPLE 48

Preparing Toner 16

The preparation process was the same as that for preparing toner 1 except that the resin particle (1) was substituted with the resin particle (16). The resultant toner is referred to as toner 16.

### EXAMPLE 49

Preparing Comparative Toner 1

To 200 g of 5 wt. % sodium dodecyl benzene sulfonate solution which had been heated to 85° C., 15 g of docosanoic acid docosyl ester which had been heated to 85° C. was added. The mixture was dispersed by CLEARMIX until the number average primary particle size reached 120 nm, cooled to 30° C. to yield a dispersion solution of docosanoic acid docosyl ester (A1).

To 200 g of 5 wt. % sodium dodecyl benzene sulfonate solution, 8 g of carbon black was added. The mixture was dispersed by CLEARMIX until the number average primary particle size reached 100 nm to yield a dispersion solution of carbon black (B1).

To a glass reaction vessel equipped with a stirring device, a heating-cooling device, a concentration device, and an inlet for materials, 600 g of an aqueous solution comprising 5 wt. % sodium dodecyl benzene sulfonate and as a polymerization initiator 1.2 g of potassium persulfate were added. The resultant mixture was heated to 85° C., and a monomer solution comprising 70 g of styrene, 20 g of butyl acrylate, and 10 g of methacrylic acid was dripped within an hour for polymerization. 7 hours later, the reaction was terminated and the polymer was cooled to 20° C. to yield a resin particle (C1) with a particle size of 130 nm.

The dispersion solution of docosanoic acid docosyl ester (A1), the dispersion solution of carbon black (B1), and the resin particle (C1) was mixed with stirring at 30° C. and meanwhile 300 g of 20% magnesium chloride solution was dripped within 30 min. Subsequently, the temperature was raised to 80° C. and the growth of the particle size was monitored. When the particle size (median size of volume basis: determined by Kurt Multi sizer II manufactured by Beckman Coulter Inc.) reached 6.5 μm, 300 g of water and 10 g of NaCl were added to stop the growth of the particle size. The temperature was further raised to 95° C., and spherical shape particles form gradually within 5 hours. After the shape coefficient reaches 0.965 (determined by FPIA-3000), the solution was cooled to 20° C., filtered by a centrifugal separator, rinsed by water, and dried by a vacuum dryer. 100 g of the dried particle was collected, and 1 g of hydrophobic silicon dioxide (treated with Hexamethyldisilazane, the number average primary particle size is 12 nm) and 0.5 g of hydrophobic titanium dioxide (treated with Octyltrimethyl silane, the number average primary particle size is 25 nm) were added. The resultant mixture was blended by a Henshel mixer to yield comparative toner 1.

### EXAMPLE 50

Preparing Comparative Toner 2

The preparation process was the same as that for preparing the comparative toner 1 except that the carbon black was substituted with pigment red 122. The resultant toner was comparative toner 2.

### EXAMPLE 51

Preparing Comparative Toner 3

The preparation process was the same as that for preparing the comparative toner 1 except that the carbon black was substituted with pigment yellow 74. The resultant toner was comparative toner 3.

### EXAMPLE 52

Preparing Comparative Toner 4

The preparation process was the same as that for preparing the comparative toner 1 except that the carbon black was substituted with pigment blue 15:3. The resultant toner was comparative toner 4.

Evaluation

To evaluate the fixation (roll viscosity resistance) and durability of above-prepared toners

The toners are evaluated by a non-magnetic one-component printer. The printer is ColorLaserJet 2605 manufactured by HP Inc.

Evaluation on Roll Viscosity Resistance

At low temperature and low humidity (10° C./10% RH), 1000 sheets of stipple pattern (full pixel rate is 40% halftone image) were continuously printed. The pixel rate of yellow/magenta/cyan/black is 10%. Then shut off power for a night. In the next morning, observe the fixing part visually whether the toner spits out or not.

Evaluation on Durability

At high temperature and high humidity (33° C./85% RH), 4000 sheets of stipple pattern were continuously printed under one piece intermittent mode (that is, pause for 10 seconds after each sheet is printed). The pixel rate of yellow/magenta/cyan/black is 1%. By comparing with paper reflection density which is [0], the imaging density (black) of the initial image and the 4,000th image are obtained respectively. Likewise, the fog density of the initial image and the 4,000th image are obtained. After that, compare the color gamut formed by Y/M/C and B/G/R under full-color visual observation. The concrete method is to set the color gamut area of the initial image as 100, and that of the 4,000th image is compared with the value.

The following combination of toners are used:

Embodiment 1: toner 1/toner 4/toner 7/toner 10

Embodiment 2: toner 2/toner 5/toner 8/toner 11

Embodiment 3: toner 3/toner 6/toner 9/toner 12

Embodiment 4: toner 13/toner 14/toner 15/toner 16

Comparative embodiment 1: comparative toner 1/comparative toner 2/comparative toner 3/comparative toner 4

Evaluation Results

| | Whether spit out |
|---|---|
| | after 1000th imaging |
| Embodiment 1 | no |
| Embodiment 2 | no |
| Embodiment 3 | no |
| Embodiment 4 | no |
| Comparative embodiment 1 | slightly |

| | Initial stage | | | After 4000th imaging | | |
|---|---|---|---|---|---|---|
| | Imaging | | | Imaging | | |
| | density | Fog | Color | density | Fog | Color |
| | (black) | density | gamut | (black) | density | gamut |
| Embodiment 1 | 1.41 | 0.000 | 100 | 1.40 | 0.000 | 99 |
| Embodiment 2 | 1.40 | 0.000 | 100 | 1.40 | 0.000 | 99 |
| Embodiment 3 | 1.41 | 0.000 | 100 | 1.41 | 0.000 | 99 |
| Embodiment 4 | 1.41 | 0.000 | 100 | 1.41 | 0.000 | 99 |
| Comparative | 1.38 | 0.000 | 100 | 1.26 | 0.006 | 87 |
| embodiment 1 | | | | | | |

According to the results, the toner of the invention can maintain long-term stable performance.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for producing an electrostatic image-developing toner comprising the steps of:
a) adding a free radical polymerizable monomer to an aqueous medium comprising dispersed wax particles containing a colorant;
b) polymerizing said free radical polymerizable monomer to yield resin particles comprising said wax particles and said colorant; and
c) agglutinating and fusing said resin particles in said aqueous medium to yield a toner.

2. The method of claim 1, wherein said free radical polymerizable monomer comprises styrene, α-methyl styrene, chlorine styrene, dichlorostyrene, p-tert-butyl styrene, p-n-butyl styrene, p-n-nonyl styrene, methyl acrylate, ethyl acrylate, propyl acrylate, butyl acrylate, iso-butyl acrylate, 2-hydroxyethyl acrylate, ethylhexyl acrylate, methyl methacrylate, ethyl methacrylate, propyl methacrylate, butyl methacrylate, iso-butyl methacrylate, hydroxyethyl methacrylate, and ethylhexyl methacrylate.
